(19) United States
(12) Patent Application Publication
(10) Pub. No.: US 2024/0250567 A1
(43) Pub. Date: Jul. 25, 2024

(54) Rotor Device and Electric Motor

(71) Applicant: Robert Bosch GmbH, Stuttgart (DE)

(72) Inventors: Csongor Horvath, Budapest (HU); Vilmos Paiss, Budapest (HU)

(21) Appl. No.: 18/006,667

(22) PCT Filed: Jul. 22, 2021
(86) PCT No.: PCT/EP2021/070508

§ 371 Date: Jun. 21, 2023

(30) Foreign Application Priority Data
Jul. 27, 2020 (DE) 10 2020 209 436.5

(51) Int. Cl. H02K 1/2796; H02K 21/24

(52) U.S. Cl. CPC H02K 1/2796; H02K 21/24

(57) ABSTRACT

A rotor device for an electric motor, in particular for an axial flux reluctance electric motor, includes (i) a rotor unit which is provided to be made to move in a rotational movement about an axis of rotation at least partially by a reluctance force, and (ii) at least one rotor body. The at least one rotor body is designed at least substantially as a hollow cylindrical disk.

### PRIOR ART

A rotor device for an electric motor, in particular for an axial flux reluctance motor, comprising at least one rotor unit which is provided to be made to move in a rotational movement about an axis of rotation at least partially by a reluctance force and which comprises at least one rotor body has already been proposed.

### DISCLOSURE OF THE INVENTION

The invention proceeds from a rotor device for an electric motor, in particular for an axial flux reluctance motor, comprising at least one rotor unit which is provided to be made to move in a rotational movement about an axis of rotation at least partially by a reluctance force and which comprises at least one rotor body.

It is proposed that the at least one rotor body is designed at least substantially as a hollow cylindrical disk.

Preferably, the electric motor is designed as a reluctance motor. The electric motor can be designed as an induction machine, in particular as a squirrel cage rotor. Preferably, the electric motor is designed as an axial flux reluctance motor which generates the reluctance force by at least one magnetic field oriented at least substantially axially, in particular at least substantially in parallel with the axis of rotation. A “magnetic field” is preferably to be understood as a magnetic flux, in particular a B field. The term “substantially in parallel” is to be understood here in particular to mean an orientation of a direction relative to a reference direction, in particular in a plane, the direction having a deviation in particular of less than 8°, advantageously less than 5°, and particularly advantageously less than 2°, from the reference direction. “At least substantially axially” is to be understood in particular to mean at least substantially parallel to the axis of rotation. A “rotor device” is preferably to be understood to mean at least a part, preferably a subassembly, of an electric motor, preferably a reluctance motor. In particular, the rotor device can also comprise the entire electric motor, in particular the entire reluctance motor. Preferably, the rotor device is provided for generating a torque. The term “provided” is to be understood in particular as specially configured, specially designed, and/or specially equipped. The fact that an object is provided for a specific function is preferably to be understood in particular to mean that the object fulfills and/or executes this specific function in at least one application state and/or operating state. An “operating state” is preferably to be understood as a state in which the rotor device is operationally ready for a rotational process and/or a rotational operation and/or is in a rotational operation in which at least one magnetic field, in particular the reluctance force, acts on the rotor body of the rotor unit, in particular of the rotor device, in particular of the electric motor, for the purpose of generating the torque. Preferably, the electric motor has a stator unit for generating the at least one magnetic field. Preferably, the stator unit has a plurality of electromagnets, which in particular each generate a magnetic field and by means of which in particular the reluctance force is at least partially generated. The stator unit is preferably designed as an immovable part of the electric motor. The rotor unit is preferably designed as a movable, in particular rotatably mounted, part of the electric motor. The rotor unit preferably comprises at least one rotor body which is arranged on at least one electromagnet of the stator unit, in particular in order to be made to rotate by the electromagnet. The at least one rotor body is preferably formed from a material that conveys a magnetic flux.

The fact that “the at least one rotor body is designed at least substantially as a hollow cylindrical disk” is preferably to be understood to mean that the at least one rotor body extends physically from an inner radius, in particular which is non-zero, radially out to an outer radius, wherein the rotor body has, in particular along the axis of rotation, a maximum extension which is preferably shorter than a maximum extension perpendicular to the axis of rotation, wherein the rotor body can have recesses between the inner radius and the outer radius which are at least partially delimited by the physical extensions of the rotor body and wherein the rotor body has, in particular in the direction of the axis of rotation, outer base sides which can be designed in particular differently from a uniformly even surface. In particular, the rotor body has at least substantially the shape of a dumbbell. Preferably, the rotor body has two outer base sides facing away from one another in the axial direction, in particular in the direction of the axis of rotation. Preferably, the at least two outer base sides are designed identically, in particular identically structured. Preferably, the outer base sides have at least one reluctance region which is provided to be arranged at least largely in the at least one magnetic field, in particular for conveying the reluctance force. Preferably, the at least one rotor body, in particular the reluctance region, in particular at least in the operating state, is arranged between at least two electromagnets. Preferably, the at least one rotor body delimits at least one body recess for a connection to a rotor shaft, which body recess is in particular at least substantially limited to a circular shape and is arranged in particular centrally on the outer base side. Preferably, the body recess is limited by the rotor body to an extension within the inner radius. The at least one rotor shaft preferably has a longitudinal axis which is oriented at least substantially in parallel with the axis of rotation. Preferably, the rotor shaft extends along the axis of rotation. The at least one rotor body can be connected directly or indirectly to the at least one rotor shaft. The rotor unit can comprise at least one connecting element, for example at least one spoke element, differential element, and/or ring element, which is provided to connect the at least one rotor shaft to the at least one rotor body. Preferably, the rotor body is arranged at a distance from the axis of rotation, in particular through the body recess. The at least one rotor body preferably has a longitudinal axis which is oriented at least substantially perpendicularly to the axis of rotation. A “longitudinal axis” of an object is to be understood in particular as an axis which runs in parallel with a longest edge of a smallest geometric cuboid which substantially completely encloses the object, and preferably runs through a geometric center point of the object. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°.

An advantageously uniform rotor body for a reluctance motor can be formed by the embodiment of the rotor device according to the invention. An advantageous weight distribution on the rotor body can be achieved. In particular, an advantageous distribution of moment of inertia on the rotor body can be achieved. In particular, an advantageously rotational-position-independent torque can be achieved. In particular, an advantageously uniformly generatable torque can be achieved. In particular, an advantageously stable rotor body can be formed. In particular, an advantageously small torque fluctuation can be achieved. In particular, an advantageous ratio of the highest possible induction to the smallest possible induction can be achieved by the rotor body. In particular, high torque densities and/or power densities can advantageously be achieved.

Furthermore, it is proposed that the at least one rotor body has one, in particular the already mentioned, outer base side which, in particular at an end of the rotor body facing away from the axis of rotation, has at least one bevel and/or rounding. The reluctance region of the outer base sides is preferably arranged at an end of the rotor body facing away from the axis of rotation. Preferably, a maximum extension of the rotor body along the axis of rotation is dependent on a distance from the axis of rotation. Preferably, the rotor body has a maximum extension along the axis of rotation at a first distance from the axis of rotation which is different from a maximum extension of the rotor body along the axis of rotation at a further distance from the axis of rotation. Preferably, the rotor body has, at a first distance from the axis of rotation, a maximum extension along the axis of rotation which is smaller than a maximum extension of the rotor body along the axis of rotation at a second distance from the axis of rotation which is greater than the first distance. Alternatively, the rotor body can have, at a first distance from the axis of rotation, a maximum extension along the axis of rotation which is greater than a maximum extension of the rotor body along the axis of rotation at a second distance from the axis of rotation which is greater than the first distance. Preferably, one of the outer base sides, preferably both outer base sides, has/have a shape different from a flat surface, in particular at least in the reluctance region. Preferably, the outer base side is designed differently from a lateral side. Preferably, one of the outer base sides, preferably both outer base sides, has/have at least one bevel and/or rounding, in particular at least in the reluctance region. For example, in a cross section through an axis of rotation of the rotor body, the outer base sides form an I shape, a V shape, an A shape or an X shape together with the lateral side, at least in the reluctance region. Preferably, the rotor body tapers conically at least in sections in a cross section through the axis of rotation of the rotor body in the reluctance region. For example, in a cross section through the axis of rotation of the rotor body in the reluctance region, the rotor body can taper conically toward the axis of rotation, toward the lateral side, and/or from both sides toward a center axis of the reluctance region. Preferably, at least one outer base side, preferably both outer base sides, of the at least one rotor body, at least in the reluctance region, is/are formed at least partially with an outer surface which is oriented differently from a perpendicular orientation with respect to the axis of rotation. Preferably, the rotor body is thinner on a center ring end facing the axis of rotation, in particular with respect to an extension in the direction of the axis of rotation, than on an outer ring end facing away from the axis of rotation. A lighter rotor body that can advantageously be driven more easily in particular in the reluctance region can be achieved in this way. A “bevel” is preferably also to be understood as an angled face. An advantageous weight reduction, in particular a reduction in the moment of inertia, of the rotor body can be achieved in this way. In particular, an advantageously large dynamic torque range can be achieved by the rotor body. In particular, the rotor body can advantageously be smoothly initiated into a rotational movement.

It is further proposed that the rotor unit comprises at least one, in particular the already mentioned, rotor shaft, which is at least partially designed as a hollow cylinder and which is connected to the rotor body. Preferably, the rotor body is connected to the rotor shaft immovably relative to the rotor shaft. The rotor shaft preferably delimits at least one shaft recess. Preferably, the shaft recess is at least partially limited to an extension along the axis of rotation. Preferably, the at least one shaft recess is formed without any delimitation by the rotor shaft on one side, in particular along the axis of rotation. The at least one rotor shaft can delimit at least two, in particular several, shaft recesses. The fact that “the at least one rotor shaft is at least partially designed as a hollow cylinder” is preferably to be understood as meaning that the at least one rotor body, in particular at least in sections along the axis of rotation, extends physically from a shaft inner radius, which in particular is non-zero, radially out to a shaft outer radius, wherein the rotor shaft has, in particular along the axis of rotation, a maximum extension which is preferably longer than a maximum extension perpendicular to the axis of rotation. An advantageously light rotor shaft can be achieved. In particular, an advantageous moment of inertia of the rotor shaft can be achieved, in particular with respect to torque absorption and/or a rotational operation.

Furthermore, it is proposed that the at least one rotor shaft is designed as a hollow cylinder at least in a connection region with the rotor body. The at least one rotor shaft is preferably designed as a hollow cylinder, at least to a large extent, preferably at least 60%, particularly preferably at least 75% and very particularly preferably at least 90%, in relation to the maximum extension of the rotor shaft along the axis of rotation. Preferably, the at least one rotor shaft is formed in each connection region with a rotor body as a hollow cylinder. An advantageous distribution of stability and lightweight construction along the longitudinal axis of the rotor shaft can be achieved.

It is further proposed that the at least one rotor body extends at least partially physically from an inner radius radially out to an outer radius, and the rotor body has at least one radial recess between the inner radius and the outer radius. The at least one radial recess is preferably limited to a maximum extension which is oriented radially. Preferably, the at least one rotor body has, in particular between the inner radius and the outer radius, a plurality of identically shaped radial recesses. The fact that “the rotor body has a radial recess” is to be understood in particular to mean that the at least one rotor body, in particular between the inner radius and the outer radius, delimits several identically shaped radial recesses. Preferably, the at least one rotor body has, in particular between the inner radius and the outer radius, a plurality of identically shaped radial recesses. Preferably, the at least one rotor body has, in particular between the inner radius and the outer radius, a plurality of, in particular identically formed, radial recesses distributed uniformly over its entire circumference. The radial recesses are provided, in particular designed, for inhibiting the reluctance force. The radial recesses can be shaped differently. Each pair of opposing radial recesses can be shaped identically. Preferably, the at least one radial recess extends in the radial direction through the entire rotor body, in particular through the entire physical part of the rotor body. Preferably, the at least one radial recess extends in the reluctance region through the rotor body. An advantageous reluctance usage geometry of the rotor body designed as a hollow cylindrical disk can be achieved.

Furthermore, it is proposed that the at least one radial recess is limited to different extensions perpendicular to a radius around the axis of rotation in at least two distances from the axis of rotation. Preferably, the at least one radial recess is limited to different extensions perpendicular to a radius around the axis of rotation in at least three, preferably at least four, particularly preferably at least five, distances from the axis of rotation. Preferably, the at least one radial recess is delimited perpendicularly to a radial direction by surfaces of the rotor body which are different from flat surfaces. Alternatively, the at least one radial recess can be delimited perpendicularly to a radial direction by flat surfaces of the rotor body. The radial recess can be limited to a radial recess shape by radial walls of the rotor body, which shape at least partially has a constant, linear, circular, diamond-shaped, convex, concave or polynomial shape. Preferably, the at least one radial recess is limited to different extensions perpendicular to a radius around the axis of rotation in dependence on the distance from the axis of rotation. Preferably, the at least one radial recess is limited to greater extensions perpendicular to a radius around the axis of rotation at a greater distance from the axis of rotation. An advantageous radial geometry of the radial recesses can be achieved. In particular, an advantageously uniform distribution of radial recesses can be achieved. In particular, an advantageously dense uniform distribution of radial recesses can be achieved.

It is further proposed that the at least one radial recess is limited on the outer radius to a greater extension perpendicular to a radius around the axis of rotation than on the inner radius. Preferably, the at least one radial recess on the outer radius is limited to an extension, perpendicular to a radius around the axis of rotation, which is at least one-and-a-half times, preferably at least twice, particularly preferably at least three times as great as the extension of the radial recess on the inner radius perpendicular to a radius around the axis of rotation. An advantageously funnel-shaped radial recess can be achieved. In particular, a radial recess advantageously adapted to the geometry of the rotor body can be achieved.

Furthermore, it is proposed that the at least one rotor unit has at least one permanent magnet which is arranged on the at least one rotor body. Preferably, the at least one permanent magnet is arranged in the reluctance region of the rotor body. Preferably, the at least one permanent magnet is provided to generate a magnetic attractive force and/or repulsive force in addition to the reluctance force to drive the at least one rotor unit. The at least one permanent magnet can be provided to at least partially support an inhibiting of the reluctance force by the at least one radial recess. Preferably, the at least one permanent magnet is oriented at least substantially parallel to the axis of rotation, in particular in relation to a pole connection axis of the permanent magnet. Preferably, the at least one permanent magnet is oriented at least substantially perpendicularly to a direction radial to the axis of rotation, in particular with respect to a pole connection axis of the permanent magnet. A “pole connection axis” of a magnet should preferably be understood to mean an imaginary axis from a center point of a magnetic north pole of the magnet to a magnetic south pole of the magnet. An advantageous combination of magnetic force and reluctance force for driving the at least one rotor unit can be achieved. A higher power can be achieved for the same rotor body size.

It is further proposed that the at least one rotor unit has at least one permanent magnet which is arranged in the at least one radial recess. Preferably, the at least one permanent magnet has at least substantially the same shape as the at least one radial recess. Preferably, the rotor unit has at least one permanent magnet for each radial recess. Preferably, at least one permanent magnet is arranged in each radial recess. Preferably, the at least one permanent magnet is arranged centrally, in particular with respect to a direction of the axis of rotation, in particular with respect to a direction radial to the axis of rotation, in the at least one radial recess. The at least one permanent magnet preferably fills the at least one radial recess at least substantially completely. An advantageously trapped permanent magnet can be achieved. In particular, an advantageous rotor body geometry with respect to an inhibition and a facilitation of the reluctance force can be achieved.

Furthermore, it is proposed that the at least one rotor unit has at least one permanent magnet which is arranged on an outer base side of the rotor body. The at least one permanent magnet is preferably arranged on the outside of the rotor body in a region of the at least one radial recess. Preferably, the at least one rotor unit has at least one permanent magnet for each radial recess, and each permanent magnet is arranged on the outside of the rotor body in a region of the respective radial recesses. An advantageous reinforcement of the rotor geometry, in particular with respect to the utilization and inhibiting of the reluctance force and/or a magnetic force, can be achieved. In particular, a distance between the rotor unit and the stator unit in the reluctance region can advantageously be reduced.

It is further proposed that the at least one rotor unit has at least two permanent magnets which are arranged on different outer base sides of the rotor body. Preferably, the at least two permanent magnets are arranged opposite the rotor body, in particular on the outer base sides, in particular along the axis of rotation. Preferably, the at least two permanent magnets are shaped identically. Preferably, the at least two permanent magnets are oriented identically, in particular with respect to the pole connection axes of the permanent magnets. The at least two permanent magnets can alternatively be in opposite orientation, in particular with respect to their respective pole connection axes. Preferably, the rotor unit has at least two permanent magnets for each radial recess, which are arranged in particular on different outer base sides of the rotor body. Preferably, the rotor unit has at least two permanent magnets for each radial recess, which are arranged in particular opposite, in particular on the outside, on the rotor body, in particular on the outer base sides, in particular along the axis of rotation. An advantageously symmetrical distribution of permanent magnets on the rotor body can be achieved. An advantageous reinforcement of an inhibiting effect of the radial recess can be achieved.

Furthermore, it is proposed that the at least one rotor unit has at least two permanent magnets, one of the at least two permanent magnets being arranged in the at least one radial recess and the other of the at least two permanent magnets being arranged on an outer base side of the rotor body. Preferably, the rotor unit has at least three permanent magnets for each radial recess, wherein two permanent magnets are arranged in particular on different outer base sides of the rotor body in the region of the radial recess, and one permanent magnet is arranged in the given radial recess. Preferably, the rotor unit has at least three permanent magnets for each radial recess, wherein in particular two permanent magnets are arranged, in particular on the outside, opposite one another on the rotor body, in particular on the outer base sides, in particular along the axis of rotation, and one permanent magnet is arranged between the two opposing permanent magnets in a radial recess. Preferably, the at least three permanent magnets are oriented identically, in particular with respect to the pole connection axes of the permanent magnets. The at least three permanent magnets can alternatively be partially oriented in opposite directions, in particular with respect to their respective pole connection axes. An advantageously symmetrical distribution of permanent magnets on the rotor body can be achieved. An advantageous reinforcement of an inhibiting effect of the radial recess can be achieved. In particular, an advantageously high power density, in particular an advantageously high torque density, in particular through the rotor unit, can be achieved.

Furthermore, an electric motor is proposed, having a motor housing and having a rotor device according to the invention. The electric motor preferably has a bearing unit which rotatably supports the at least one rotor unit in the motor housing. Preferably, the electric motor is designed as part of a vehicle, in particular as part of an elevator, an aircraft, a train, a road vehicle, such as a quad, a commercial truck, or a passenger car, a boat, or a jet ski.

The rotor device according to the invention and/or the electric motor according to the invention should not be limited to the application and embodiment described above. In particular, in order to fulfill a functionality described herein, the rotor device according to the invention and/or the electric motor according to the invention can have a number of individual elements, components and units that deviates from the number mentioned herein. In addition, in the case of the value ranges specified in this disclosure, values within the mentioned limits are also to be considered as disclosed and usable as desired.

### DRAWINGS

Further advantages result from the following description of the drawings. An embodiment of the invention is illustrated in the drawings. The drawings, the description and the claims contain numerous features in combination. A person skilled in the art will expediently also consider the features individually and combine them to form meaningful further combinations.

In the drawings:

FIG. 1 shows an electric motor according to the invention, having a rotor device according to the invention, in a schematic sectional illustration along an axis of rotation,

FIG. 2 is a schematic view of a rotor device according to the invention,

FIG. 3 shows a rotor device according to the invention in a schematic sectional illustration along a III-III sectional plane, and

FIG. 4 shows a rotor device according to the invention in a further schematic sectional illustration along a IV-IV sectional plane.

### DESCRIPTION OF THE EXEMPLARY EMBODIMENT

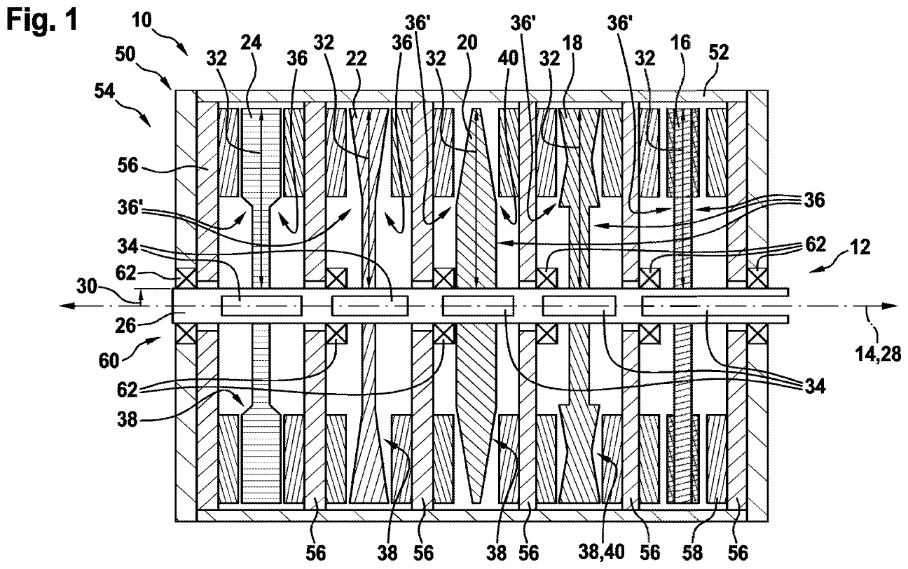

FIG. 1 shows an electric motor 50. The electric motor 50 is designed as an axial flux reluctance electric motor. In particular, the electric motor 50 is designed to generate a torque at least partially, in particular exclusively, by a reluctance force. The electric motor 50 has a motor housing 52. The electric motor 50 comprises a rotor device 10. The rotor device 10 is designed specifically for use in the electric motor 50.

The rotor device 10 comprises a rotor unit 12. The rotor unit 12 is provided to be made to move in a rotational movement about an axis of rotation 14 by the reluctance force.

The rotor device 10 comprises a stator unit 54. The stator unit 54 is arranged immovably relative to the motor housing 52. The stator unit 54 is arranged immovably in particular with respect to the axis of rotation 14. The stator unit 54 comprises, by way of example, six stator bodies 56, on each of which electromagnets 58 are arranged for generating a magnetic field oriented axially, in particular along the axis of rotation 14, in particular for generating the reluctance force. To provide a clearer overview, only one electromagnet 58 is provided with a reference sign. Along the axis of rotation 14, at least one rotor body 16, 18, 20, 22, 24 is arranged between two stator bodies 56.

The rotor unit 12 comprises five, in particular different, rotor bodies 16, 18, 20, 22, 24. The rotor unit 12 comprises a rotor shaft 26. The rotor shaft 26 is connected to the at least one rotor body 16, 18, 20, 22, 24. The rotor bodies 16, 18, 20, 22, 24 are connected to the rotor shaft 26. The rotor shaft 26 is provided to form a torque that is transmitted from the rotor bodies 16, 18, 20, 22, 24 to the rotor shaft 26 and that can be tapped outside the motor housing 52. The rotor shaft 26 has a longitudinal axis 28 which is oriented parallel to the axis of rotation 14. The longitudinal axis 28 of the rotor shaft 26 extends along the axis of rotation 14. The rotor shaft 26 defines, in particular, the axis of rotation 14 via the, in particular a centered, longitudinal axis 28 of the rotor shaft 26. The rotor unit 12 is rotatably mounted in particular by a bearing unit 60 of the electric motor 50 on the stator unit 54 and the motor housing 52. The bearing unit 60 comprises a plurality of pivot bearing elements 62.

The rotor shaft 26 is at least partially designed as a hollow cylinder. The rotor shaft 26 is formed in at least one connection region with one of the rotor bodies 16, 18, 20, 22, 24 as a hollow cylinder. The rotor shaft 26 is formed in all connection regions with the rotor bodies 16, 18, 20, 22, 24 as a hollow cylinder. In particular, the rotor shaft 26 delimits several, in particular five, shaft recesses 34. The shaft recesses 34 are each limited to a maximum extension which is oriented along the axis of rotation 14. One of the shaft recesses 34 is formed without any delimitation by the rotor shaft 26 on one side, in particular along the axis of rotation 14.

The five rotor bodies 16, 18, 20, 22, 24 are each designed as, in particular different, in particular differently shaped, hollow cylindrical disks. The five rotor bodies 16, 18, 20, 22, 24 extend at least partially physically from an inner radius 30 radially out to an outer radius 32. The five rotor bodies 16, 18, 20, 22, 24 each have two outer base sides 36, 36′. The outer base sides 36, 36′ are each opposite sides of the rotor bodies 16, 18, 20, 22, 24 in the direction of the axis of rotation 14. The outer base sides 36, 36′ of the rotor bodies 16, 18, 20, 22, 24 face hypothetical ends of the axis of rotation 14. The outer base sides 36, 36′ of each rotor body 16, 18, 20, 22, 24 are each designed analogously to each other, in particular mirrored.

The at least one rotor body 18, 20, 22, 24 has an outer base side 36, 36′ which has at least one bevel 38 and/or at least one rounding 40. An edge of a bevel 38 on the outer base side 36, 36′ can be rounded. In particular, an edge of the bevels 38 on two of the rotor bodies 16, 20 is rounded. The bevel 38 and/or rounding 40 is in particular arranged at an end of three of the rotor bodies 18, 20, 22 remote from the axis of rotation 14.

In a cross section along the axis of rotation 14 through the rotor bodies 16, 18, 20, 22, 24, the rotor body 16 has an I shape. Viewed in the cross section along the axis of rotation 14 through the rotor bodies 16, 18, 20, 22, 24, the rotor body 18 has an X shape on one side, proceeding from the axis of rotation 14, on the end of the rotor body 18 which is remote from the axis of rotation 14. Viewed in the cross section along the axis of rotation 14 through the rotor bodies 16, 18, 20, 22, 24, the rotor body 20 has an A shape on one side, proceeding from the axis of rotation 14, on the end of the rotor body 20 which is remote from the axis of rotation 14. Viewed in the cross section along the axis of rotation 14 through the rotor bodies 16, 18, 20, 22, 24, the rotor body 22 has a V shape on one side, proceeding from the axis of rotation 14, on the end of the rotor body 22 which is remote from the axis of rotation 14. Viewed in the cross section along the axis of rotation 14 through the rotor bodies 16, 18, 20, 22, 24, the rotor body 24 has an I shape on one side, proceeding from the axis of rotation 14, on the end of the rotor body 24 which is remote from the axis of rotation 14.

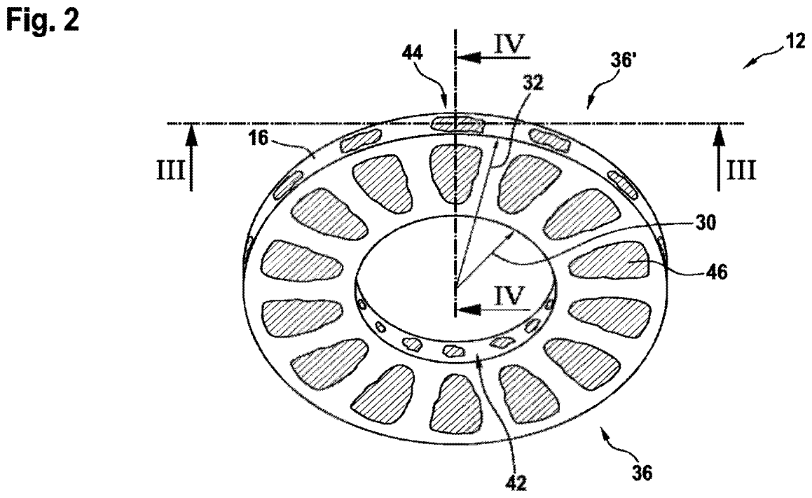

In FIGS. 2 to 4, the rotor body 16 is used as an example for the rotor bodies 16, 18, 20, 22, 24. The features described in FIGS. 2 to 4 on the basis of the rotor body 16 can in principle be transferred to the other rotor bodies 18, 20, 22, 24.

FIG. 2 shows in particular that the at least one rotor body 16 is designed as a hollow cylindrical disk. The at least one rotor body 16 extends physically from an inner radius 30 radially out to an outer radius 32. By way of example, all rotor bodies 16, 18, 20, 22, 24 extend physically from the same inner radius 30 radially out to the same outer radius 32 (see FIG. 1). In principle, different inner radii 30 and/or outer radii 32 can be formed for each rotor body 16, 18, 20, 22, 24.

For a connection to the rotor shaft 26, the rotor body 16 delimits a body recess 42 which is limited to a circular shape and which is arranged centrally on the outer base sides 36, 36′ of the rotor body 16. The body recess 42 of the rotor body 16 is limited by the rotor body 16 to an extension within the inner radius 30. The body recess 42 is provided to enable a formfitting connection of the rotor body 16 to the rotor shaft 26. In particular, the rotor shaft 26 is provided to be inserted through the body recess 42.

The rotor body 16 has at least one radial recess 44 between the inner radius 30 and the outer radius 32. To provide a clearer overview, only one radial recess 44 is provided with a reference sign. The rotor body 16 has fourteen radial recesses 44, for example, between the inner radius 30 and the outer radius 32. Radial recesses 44 are arranged radially opposite each other in pairs. The radial recesses 44 are, for example, formed without any delimitation by the rotor body 16 in the radial direction. The radial recesses 44 are limited to a maximum extension which is radially oriented up to a deviation of at most 25°.

The rotor unit 12 has at least one permanent magnet 46. The rotor unit 12 has forty-two permanent magnets 46 in particular for each rotor body 16, 18, 20, 22, 24. To provide a clearer overview, only one permanent magnet 46 is provided with a reference sign in FIGS. 2 to 4. The rotor unit 12 has three permanent magnets 46 in particular for each rotor body 16, 18, 20, 22, 24, for each radial recess 44. The permanent magnets 46 are arranged on the rotor body 16 (cf. FIGS. 2 to 4). Two thirds—in particular, twenty-eight— of the permanent magnets 46 are arranged on the outer base sides 36, 36′ of the rotor body 16 (see FIG. 2 and FIG. 4). Two thirds— in particular, twenty-eight— of the permanent magnets 46 are arranged in regions of the radial recesses 44 on the outside of the outer base sides 36, 36′ of the rotor body 16 (see FIG. 2 and FIG. 4). The individual permanent magnets 46 of the permanent magnets 46 arranged on the outer base sides 36, 36′ are each arranged at a distance from one another.

The individual permanent magnets 46 of the permanent magnets 46 arranged on the outer base sides 36, 36′ are arranged radially opposite one another.

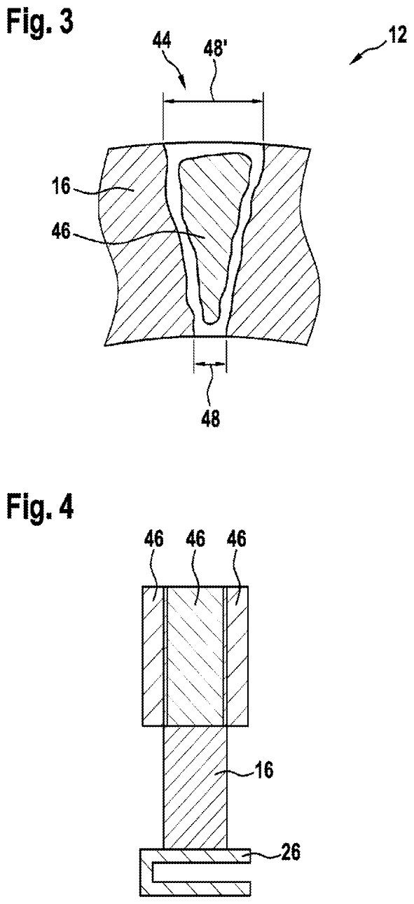

FIG. 3 shows the rotor body 16 in a sectional view along a III-III sectional plane. The at least one radial recess 44 is limited to different extensions 48, 48′ perpendicular to a radius around the axis of rotation 14 in at least two distances from the axis of rotation 14. On the outer radius 32, the at least one radial recess 44 is limited to a greater extension 48′ perpendicular to a radius around the axis of rotation 14 than on the inner radius 30. On the inner radius 30, the at least one radial recess 44 is limited to a lesser extension 48 perpendicular to a radius around the axis of rotation 14 than on the outer radius 32. One of the permanent magnets 46 is arranged in the at least one radial recess 44. FIG. 3 shows schematically, in particular broadly, that the permanent magnets 46 have a clearance in radial recesses 44 to allow for embedding, in particular for an adhesive connection.

FIG. 4 shows one half of the rotor body 16, in particular as viewed from the axis of rotation 14, in a sectional illustration along a IV-IV sectional plane. The rotor unit 12 has at least two permanent magnets 46. The at least two permanent magnets 46 are arranged on different outer base sides 36, 36′ of the rotor body 16. FIG. 4 shows the permanent magnets 46 on a radial recess 44 on the rotor body 16 as representative of all radial recesses 44 on the rotor bodies 16, 18, 20, 22, 24. The permanent magnet 46 in the radial recess 44 fills the radial recess 44 completely apart from adhesive elements (not shown).

One of the, in particular at least two, permanent magnets 46 is arranged in the at least one radial recess 44, and the other, in particular two other, permanent magnets 46, of the in particular at least two permanent magnets are arranged on an outer base side 36, 36′ of the rotor body 16.

Of the three permanent magnets 46 for each radial recess 44 on each rotor body 16, 18, 20, 22, 24, two are arranged on each respective outer base side 36, 36′. Of the three permanent magnets 46 for each radial recess 44 on each rotor body 16, 18, 20, 22, 24, one is arranged in each respective radial recess 44. All permanent magnets 46, in particular the at least one permanent magnet 46, are connected to the rotor body 16.

1. A rotor device for an electric motor, comprising:
a rotor unit which is configured to move in a rotational movement about an axis of rotation at least partially by a reluctance force; and
at least one rotor body,
wherein the at least one rotor body is designed at least substantially as a hollow cylindrical disk.

2. The rotor device according to claim 1, wherein the at least one rotor body has an outer base side which has at least one bevel and/or at least one rounding.

3. The rotor device according to claim 1, wherein the rotor unit comprises at least one rotor shaft which is at least partially designed as a hollow cylinder and which is connected to the at least one rotor body.

4. The rotor device according to claim 3, wherein the at least one rotor shaft is designed as a hollow cylinder at least in a connection region with the at least one rotor body.

5. The rotor device according to claim 1, wherein:
the at least one rotor body extends at least partially physically from an inner radius radially out to an outer radius, and
the at least one rotor body has at least one radial recess between the inner radius and the outer radius.

6. The rotor device according to claim 5, wherein the at least one radial recess is limited to different extensions perpendicular to a radius around the axis of rotation in at least two distances from the axis of rotation.

7. The rotor device at least according to claim 5, wherein the at least one radial recess is limited on the outer radius to a greater extension perpendicular to a radius around the axis of rotation than on the inner radius.

8. The rotor device according to claim 1, wherein the at least one rotor unit has at least one permanent magnet which is arranged on the at least one rotor body.

9. The rotor device at least according to claim 5, wherein the at least one rotor unit has at least one permanent magnet which is arranged in the at least one radial recess.

10. The rotor device according to claim 1, wherein the at least one rotor unit has at least one permanent magnet which is arranged on an outer base side of the rotor body.

11. The rotor device according to claim 1, wherein the at least one rotor unit has at least two permanent magnets which are arranged on different outer base sides of the rotor body.

12. The rotor device at least according to claim 5, wherein the at least one rotor unit has at least two permanent magnets, one of the at least two permanent magnets being arranged in the at least one radial recess and the other of the at least two permanent magnets being arranged on an outer base side of the rotor body.

13. An electric motor, comprising:
a motor housing; and
a rotor device according to claim 1.

14. The rotor device according to claim 1, wherein the electric motor is an axial flux reluctance electric motor.

15. The rotor device according to claim 1, wherein the at least one rotor body has an outer base side which, at an end of the rotor body facing away from the axis of rotation, has at least one bevel and/or at least one rounding.
